(19) United States
(12) Patent Application Publication
(10) Pub. No.: US 2016/0150522 A1
(43) Pub. Date: May 26, 2016

(54) UPLINK RESOURCE MANAGEMENT DURING RADIO LINK CONTROL (RLC) TRANSMISSION WINDOW FULL STATE

(71) Applicant: QUALCOMM Incorporated, San Diego, CA (US)

(72) Inventors: Sitaramanjaneyulu KANAMARLAPUDI, San Diego, CA (US); Arvindhan KUMAR, San Diego, CA (US); Nikhil Abhay PAI, San Diego, CA (US); Chetan Gopalakrishnan CHAKRAVARTHY, San Diego, CA (US)

(21) Appl. No.: 14/719,152

(22) Filed: May 21, 2015

Related U.S. Application Data
(60) Provisional application No. 62/083,064, filed on Nov. 21, 2014.

(51) Int. Cl. H04W 72/04

(52) U.S. Cl. CPC H04W 72/0413

(57) ABSTRACT

The present disclosure presents a method and an apparatus for uplink resource management at a user equipment (UE). For example, the disclosure presents a method for uplink resource management at a UE by detecting that a radio link control (RLC) transmission window is full at the UE after acquiring high speed-random access channel (HS-RACH) resources, initiating a message from the UE to a network entity in response to the detection for triggering transmission of a status protocol data unit (PDU) from the network entity to the UE, and receiving the status PDU from the network entity in response to the transmission. The present disclosure may also include transmitting new PDUs or re-transmitting un-acknowledged PDUs to the network entity based at least on information received in the status PDU. As such, uplink resource management at a UE may be achieved.

### CLAIM OF PRIORITY

The present application for patent claims priority to U.S. Provisional Patent Application No. 62/083,064, filed Nov. 21, 2014, entitled “Uplink Resource Management During Radio Link Control (RLC) Transmission Window Full Condition,” which is assigned to the assignee hereof, and hereby expressly incorporated by reference herein.

### BACKGROUND

The present disclosure relates generally to communication systems, and more particularly, to access control mechanism.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

According to current 3GPP Standards, a user equipment (UE) can request uplink (UL) resources from a network entity or base station if the total enhanced dedicated channel (E-DCH) buffer status (TEBS)>zero at the UE. However, if the UE radio link control (RLC) layer has transmitted the maximum number of protocol data units (PDUs) allowed by the window size of the sliding window protocol configured at the UE, and the UE has not yet received any acknowledgements (ACK) (e.g., positive acknowledgements) or negative acknowledgements (NAK) for the transmitted PDUs, the UE may not be able to transmit new PDUs or re-transmit previously transmitted PDUs on the UL as the transmission window is full at the UE. But, the UE may still continue to request UL resources from the network entity, receive UL resources from the network entity, and immediately release resources as the UE cannot transmit data because the transmission window is full at the UE. The UE may repeat this behavior until the UE is out of the transmission window full condition which may negatively affect the performance of the UE and/or the network entity.

Thus, there is a desire for a method and an apparatus for uplink resource management at the user equipment.

### SUMMARY

The following presents a simplified summary of one or more aspects in order to provide a basic understanding of such aspects. This summary is not an extensive overview of all contemplated aspects, and is intended to neither identify key or critical elements of all aspects not delineate the scope of any or all aspects. Its sole purpose is to present some concepts of one or more aspects in a simplified form as a prelude to the more detailed description that is presented later.

The present disclosure presents an example method and apparatus for uplink resource management at a user equipment (UE). For example, the present disclosure presents an example method for uplink resource management which may include detecting that a radio link control (RLC) transmission window is full at the UE after acquiring high speed-random access channel (HS-RACH) resources, initiating a message from the UE to a network entity in response to the detection for triggering transmission of a status protocol data unit (PDU) from the network entity to the UE, and receiving the status PDU from the network entity in response to the transmission.

Further, the present disclosure provides an apparatus for uplink resource management at a user equipment (UE) that may include means for detecting that a radio link control (RLC) transmission window is full at the UE after acquiring high speed-random access channel (HS-RACH) resources, means for initiating a message from the UE to a network entity in response to the detection for triggering transmission of a status protocol data unit (PDU) from the network entity to the UE, and means for receiving the status PDU from the network entity in response to the transmission.

Furthermore, the present disclosure provides a non-transitory computer readable medium storing computer executable code for uplink resource management at a user equipment (UE) that may include code for detecting that a radio link control (RLC) transmission window is full at the UE after acquiring high speed-random access channel (HS-RACH) resources, code for initiating a message from the UE to a network entity in response to the detection for triggering transmission of a status protocol data unit (PDU) from the network entity to the UE, and code for receiving the status PDU from the network entity in response to the transmission.

Additionally, the present disclosure provides an apparatus for uplink resource management at a user equipment (UE) that may include a radio link control (RLC) transmission window state detecting function to detect that a radio link control (RLC) transmission window is full at the UE after acquiring high speed-random access channel (HS-RACH) resources, a status protocol data unit (PDU) initiating function to initiate a message from the UE to a network entity in response to the detection for triggering transmission of a status protocol data unit (PDU) from the network entity to the UE, and a status PDU receiving function to receive the status PDU from the network entity in response to the transmission.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system in aspects of the present disclosure;

FIG. 2 is a message flow diagram illustrating aspects of an example method in aspects of the present disclosure;

FIG. 3 is an additional message flow diagram illustrating aspects of an example method in aspects of the present disclosure;

FIG. 4 is a flow diagram illustrating aspects of an example method in aspects of the present disclosure;

FIG. 5 is a block diagram illustrating aspects of an example user equipment including a UE uplink resource management function according to the present disclosure;

FIG. 6 is a block diagram conceptually illustrating an example of a telecommunications system including a user equipment with a UE uplink resource management function according to the present disclosure;

FIG. 7 is a conceptual diagram illustrating an example of an access network including a user equipment with a UE uplink resource management function according to the present disclosure;

FIG. 8 is a conceptual diagram illustrating an example of a radio protocol architecture for the user and control plane that may be used by the user equipment of the present disclosure; and

FIG. 9 is a block diagram conceptually illustrating an example of a Node B in communication with a UE, which includes a UE uplink resource management function according to the present disclosure, in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present disclosure provides an example method and an apparatus for uplink resource management at the UE. The method and apparatus may include the UE re-transmitting the latest not yet acknowledged PDU with a poll bit set to 1 to trigger a status protocol data unit (PDU) from the network entity. Additionally, the UE may transmit a super field (SUFI) (or a poll SUFI) with the latest not yet acknowledged PDU sequence number as POLL_SN to trigger a status PDU from the network entity. This can be performed by detecting that a radio link control (RLC) transmission window is full at the UE after acquiring high speed-random access channel (HS-RACH) resources, initiating a message from the UE to a network entity in response to the detection for triggering transmission of a status protocol data unit (PDU) from the network entity to the UE, receiving the status PDU from the network entity in response to the transmission, and transmitting new PDUs or re-transmitting un-acknowledged PDUs to the network entity based at least on information received in the status PDU.

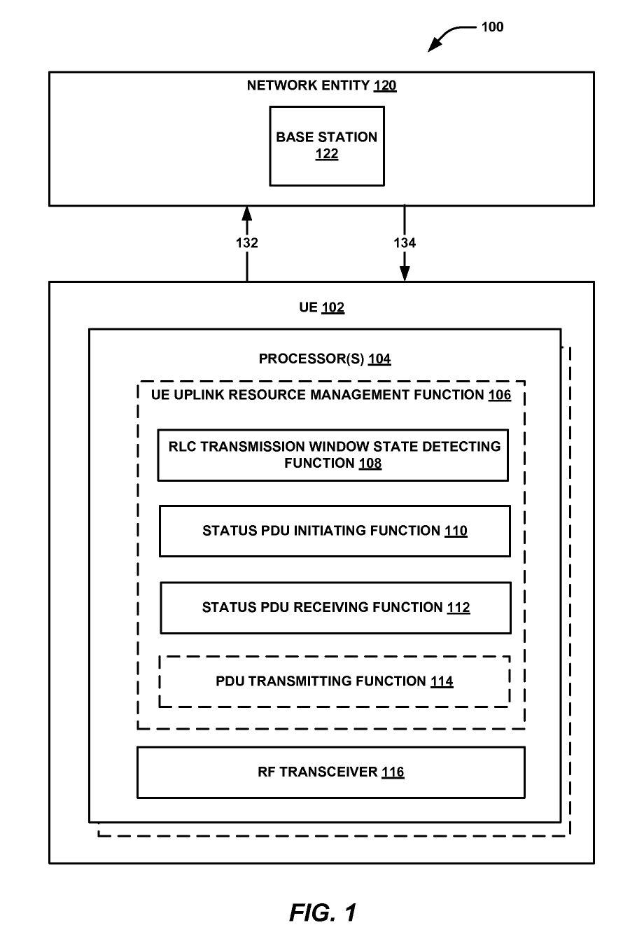

Referring to FIG. 1, in an aspect, a wireless communication system 100 includes a user equipment (UE) 102 with data for transmission on an uplink to network entity 120, one or more processors 104, and a UE uplink resource management function 106 running on processor 104 (or processors 104 in a distributed computing environment) for uplink resource management at the UE. UE 102 may communicate with network entity 120 via one or more over-the-air links 132 and/or 134. For example, UE 102 may communicate with network entity 120 or base station 122 via an uplink (UL) 132 and/or a downlink (DL) 134. In an additional, network entity 120 may include a radio network controller (RNC) 124, and/or mobile management entity (MME) 126. In an aspect, UL 132 is generally used for communication from UE 102 to network entity 120 and or base station 122, DL 134 is generally used for communication from network entity 120 and/or base station 122 to UE 102.

In an aspect, network entity 110 may include, but not limited to, an access point, a base station (BS) or Node B or eNodeB, a macro cell, a small cell (e.g., a femtocell, or a pico cell), a relay, a peer-to-peer device, an authentication, authorization and accounting (AAA) server, a mobile switching center (MSC), Mobility Management Entity (MME), SON management server, OAM server, Home NodeB Management System (HMS), Home eNodeB Management System (HeMS), etc. Additionally, network entity 110 may include one or more of any type of network components that can enable base station 120 communicate and/or establish and maintain links 132 and/or 134 with network entity 110. In an example aspect, base station 120 may operate according to Wideband Code Division Multiple Access (W-CDMA), Code Division Multiple Access (CDMA), Time Division Synchronous Code Division Multiple Access (TD-SCDMA), Long Term Evolution (LTE), or Global System for Mobile Communications (GSM) standard as defined in 3GPP Specifications.

In an additional aspect, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

The UE uplink resource management function 106 may also be configured to transmit/receive messages to network entity 120 via one or more radio frequency (RF) transceiver(s) 116. For example, UE uplink resource management function 106 may include and execute communication protocols and/or manage other standards-specific communication procedures using protocol- and/or standards-specific instructions and/or subscription-specific configuration information that allow communications with the network entity 120 and UE 102. Further, RF transceiver 116 may be configured to transmit and/or receive the communication exchange signaling to and/or from one or more base stations 122 or other devices in wireless communication system 100. For example, RF transceiver 116 may include, but is not limited to, one or more of a transmitter, a receiver, a transceiver, protocol stacks, transmit chain components, and/or receive chain components.

In an aspect, UE 102 may include a UE uplink resource management function 106 for uplink resource management at the UE by detecting that a radio link control (RLC) transmission window is full at the UE after acquiring high speed-random access channel (HS-RACH) resources, initiating a message from the UE to a network entity in response to the detection for triggering transmission of a status protocol data unit (PDU) from the network entity to the UE, receiving the status PDU from the network entity in response to the transmission, and transmitting new PDUs or re-transmitting un-acknowledged PDUs to the network entity based at least on information received in the status PDU.

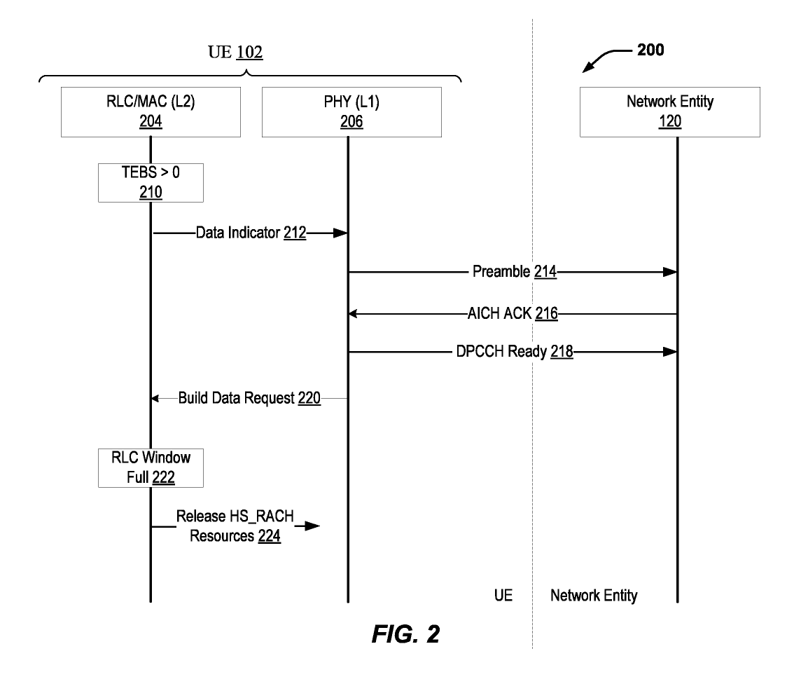

FIG. 2 illustrates an example message flow diagram 200 with radio link control (RLC) transmission window full state at the UE.

At block 210, UE 102 may detect total enhanced dedicated channel (E-DCH) buffer status (TEBS) is greater than zero at RLC/MAC 204 (e.g., radio link control (RLC) layer, L2 of UE 102). That is, UE 102 and/or E-DCH buffer has data for transmission to network entity 120. For instance, UE 102 and/or RLC/MAC 204 may detect that TEBS>0 as per 3GPP Technical Specification 25.321 (e.g., Section 11.2.2A).

At block 212, RLC/MAC 204 may transmit a data indicator to PHY 206 (e.g., physical layer, L1 of UE 102) to indicate the presence of data for transmission from UE 102 to network entity 120. At block 214, PHY 206 may initiate a preamble to network entity 120 in response to receiving data indicator 212 from RLC/MAC 204. That is, once PHY 206 receives data indicator 212 indicating data for transmission from UE 102 to network entity 120, PHY 206 transmits a preamble to network entity 120 for obtaining resources from network entity 120.

At block 216, PHY 206 may receive an acknowledgement (ACK) on an acquisition indicator channel (AICH) from network entity 120. For instance, PHY 206 may send a preamble (e.g., a first RACH preamble) 214 with a specific amount of power and may wait for a pre-defined period of time to detect whether PHY 206 receives an ACK/NAK on the AICH channel. If PHY 206 does not detect any response on the AICH channel, the preamble 214 may not have been received by network entity 120 as the power of the preamble 214 may not have been sufficient. UE 102 may send a message in the RACH channel only when PHY 206 receives an ACK on the AICH channel. Therefore, PHY 206 increases the power of preamble 214 for transmitting to network entity 120. In an aspect, AICH ACK received at PHY 206 indicates that UE 102 can transmit to network entity 120. In an additional or optional aspect, the specific amount of power used for sending preamble 214 may be calculated based on measured common pilot channel (CPICH) channel power and a set of parameters.

At block 218, PHY 206 sends dedicated physical control channel (DPCCH) Ready message 218 to network entity 120. The DPCCH Ready message 218 to network entity 120 indicates the time when DPCCH is transmitted to achieve power control balance between UE 102 and network entity 120. At block 220, PHY 206 may send build data request message 220 to RLC/MAC 204 in response to DPCCH Ready message 218 received from PHY 206. The build data request 220 message instructs RLC/MAC 204 to start building the data request so that the data in the E-DCH buffer can be transmitted from UE 102 to network entity 120.

At block 222, RLC/MAC 204 may detect that RLC transmission window full state exists at UE 102. That is, RLC/MAC 204 has sent PDUs for which it is waiting for ACK/NACKs from NW 120. For instance, the number of PDUs transmitted by UE 102 and waiting for ACK/NACK from network entity 120 may be equal to the number of PDUs allowed/configured by the sliding window protocol at UE 102. For example, UE 102 may be configured for 512 PDUs, and if RLC/MAC 204 transmitted 512 PDUs to network entity 120 and is waiting for ACK/NACKs for the transmitted PDUs (e.g., 512 PDUs), UE 102 and/or RLC/MAC 204 cannot transmit any additional PDUs to network entity 120. In an aspect, UE 102 and/or RLC/MAC 204 may be waiting for ACK/NACKs from network entity 120 due to higher block error ratio (BLER) or network entity 120 not sending the control PDU to UE 102 due to loading, scheduling, and/or configuration issues. The BLER is generally defined as the ratio of the number of erroneous blocks received to the total number of block sent, wherein an erroneous block is defined as a transport block for which cyclic redundancy check (CRC) failed.

At block 224, RLC/MAC 204 may not be able to transmit any new PDUs or re-transmit previously transmitted PDUs as the RLC transmission window is full (or in a full state). As a result, UE 102 may release HS-RACH resources. However, if TEBS>0, UE 102 may continue to acquire resources from network entity and release HS-RACH resources without transmitting any PDUs as long as RLC window full state exists at RLC/MAC 204. This may result in increase resource usage in terms of RACH procedure, collision resolution, etc. and may negatively the performance of UE 102 and/or network entity 120.

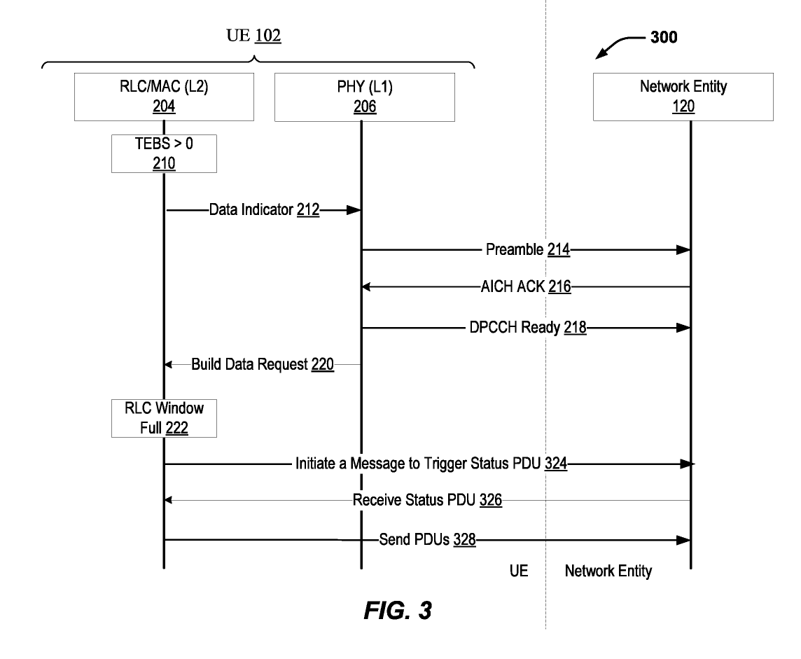

FIG. 3 illustrates an example message flow diagram 300 with a UE initiating a message to the network entity for triggering a status PDU from the network entity under RLC transmission window full state at the UE.

The messages transmitted or received at blocks 210, 212, 214, 216, 218, 220, and 220 are also illustrated in FIG. 3 for completeness. The related description of these messages transmitted/received at these block described above in reference to FIG. 2 is also applicable to FIG. 3

At block 222, once RLC/MAC 204 detects that RLC transmission window full state exists at UE 102, in an aspect, at block 324, UE 102 and/or RLC/MAC 204 may initiate a message from UE 102 to network entity 120 for triggering a status PDU from the network entity. UE 102 and/or RLC/MAC 204 may initiate the message based on detecting that the RLC transmission window is full at the UE and a build data request 220 is received at RLC/MAC 204 from PHY 206. UE 102 may initiate the message for proceeding with the transmission of data from UE 102 to network entity 120 instead of releasing HS-RACH resources due to the transmission window full state at RLC/MAC 204. A status PDU (or control PDU) is generally used in acknowledged mode (AM) RLC to transport status reports from a RLC receiver (e.g., network entity 120) to a RLC transmitter (e.g., UE 102). The status PDU lists all the missing portions of a PDU. UE 102 may further include a radio resource control (RRC) layer 202 not shown in FIGS. 2 and 3.

For instance, in an aspect, UE 102 and/or RLC/MAC 204 may initiate the message which may include re-transmitting a latest unacknowledged PDU (e.g., PDU with a sequence number of 511) with a poll bit set to a value of one. Once network entity 120 receives this message, network entity 120 triggers a status PDU to the UE which may include information on which PDUs were receives/not received and/or mission portions of a PDU at the network entity. In an additional or optional aspect, the message initiated from UE 102 to trigger a status PDU from the network may include transmitting a poll super field (SUFI) with a sequence number (SN) of a latest un-acknowledged PDU, e.g., initiating a message with a poll SUFI with a SN of 511. This allows UE 102 to receive update on whether a PDU that was transmitted earlier from the UE was received at network entity 120. As described below in detail, the triggering of status PDU from network entity 120 enables UE 120 to quickly recover from the transmission window full state at RLC/MAC 204. [Inventors: Please let me know if you believe more details about status PDU and/or SUFI have to be included, considering they are standard terms well defined in 3GP].

At block 326, UE 102 and/or RLC/MAC 204 may receive status PDU 326 from network entity 120. For example, in an aspect, UE 102 may receive the status PDU on DL 134 from network entity 120. For example, the status PDU received at the UE may indicate that the PDUs that were received, not received, or partially received at the network entity. Once RLC/MAC 204 receives the status PDU from the network entity, UE 102 and/or RLC/MAC 202 may slide the RLC transmission window at the UE as allowed by sliding window protocol so that UE 102 and/or RLC/MAC 204 may transmit new PDUs or re-transmit previously transmitted (which were not properly received at the network entity) to network entity 120.

At block 328, UE 102 and/or RLC/MAC 204 may transmit PDUs to network entity 120. In an aspect, a PDU transmitted to network entity 120 may include re-transmitting PDUs that have not been acknowledged and/or transmitting new PDUs based on the information (e.g., whether a specific PDU was acknowledged or not) received in the status PDU.

As such, uplink resource management at a UE may be achieved by triggering status PDUs at the network entity so that the UE comes out of transmission window full state and transmits new PDUs and/or re-transmits PDUs that have transmitted previously.

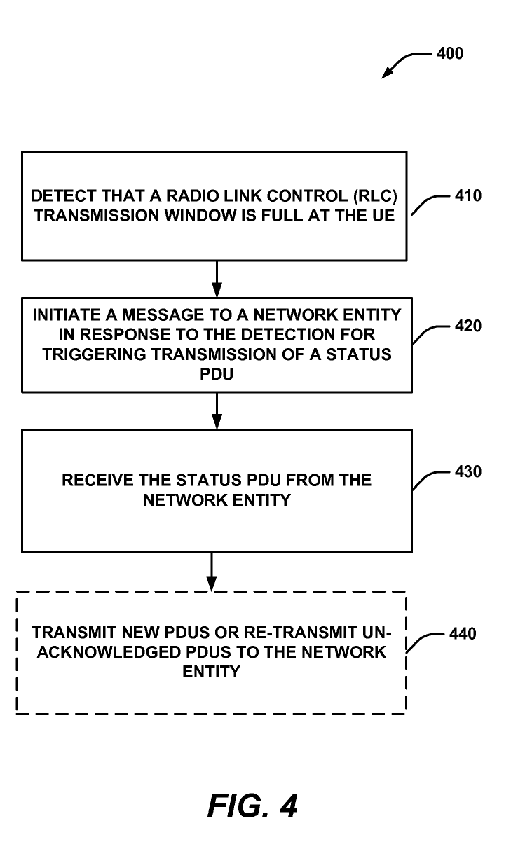

FIG. 4 illustrates an example methodology 400 for uplink resource management at a user equipment (UE).

In an aspect, at block 410, methodology 400 may include detecting that a radio link control (RLC) transmission window is full at the UE after acquiring high speed-random access channel (HS-RACH) resources. For example, in an aspect, UE 102 and/or UE uplink resource management function 106 may include a specially programmed processor module, or a processor executing specially programmed code stored in a memory, to detect that a radio link control (RLC) transmission window is full at the UE after acquiring high speed-random access channel (HS-RACH) resources. In an aspect, UE uplink resource management function 106 and/or RLC transmission window state detecting function 108 may detect that a radio link control (RLC) transmission window is full at the UE after acquiring high speed-random access channel (HS-RACH) resources.

In an aspect, at block 420, methodology 400 may include initiating a message from the UE to a network entity in response to the detection for triggering transmission of a status protocol data unit (PDU) from the network entity to the UE. For example, in an aspect, UE 102 and/or UE uplink resource management function 106 may include a specially programmed processor module, or a processor executing specially programmed code stored in a memory, to initiate a message from the UE to a network entity in response to the detection for triggering transmission of a status protocol data unit (PDU) from the network entity to the UE. In an aspect, UE uplink resource management function 106 and/or status PDU initiating function 110 may initiate a message from the UE to a network entity in response to the detection for triggering transmission of a status protocol data unit (PDU) from the network entity to the UE.

In an aspect, at block 430, methodology 400 may include receiving the status PDU from the network entity in response to the transmission. For example, in an aspect, UE 102 and/or UE uplink resource management function 106 may include a specially programmed processor module, or a processor executing specially programmed code stored in a memory, to receive the status PDU from the network entity in response to the transmission. In an aspect, UE uplink resource management function 106 and/or status PDU receiving function 112 may receive the status PDU from the network entity in response to the transmission.

In an optional aspect, at block 440, methodology 400 may optionally include transmitting new PDUs or re-transmitting un-acknowledged PDUs to the network entity based at least on information received in the status PDU. For example, in an aspect, UE 102 and/or UE uplink resource management function 106 may include a specially programmed processor module, or a processor executing specially programmed code stored in a memory, to transmit new PDUs or re-transmit un-acknowledged PDUs to the network entity based at least on information received in the status PDU. In an aspect, UE uplink resource management function 106 and/or PDU transmitting function 114 may transmit new PDUs or re-transmit un-acknowledged PDUs to the network entity based at least on information received in the status PDU.

As described above, uplink resources are managed at the UE to reduce or eliminate unnecessary resource acquisition and release which will decrease the amount of unnecessary signaling and inefficient use of resources. Additionally, by triggering or (polling) for the status PDU from the network entity, UE will be able to quickly recover from the transmission window full state.

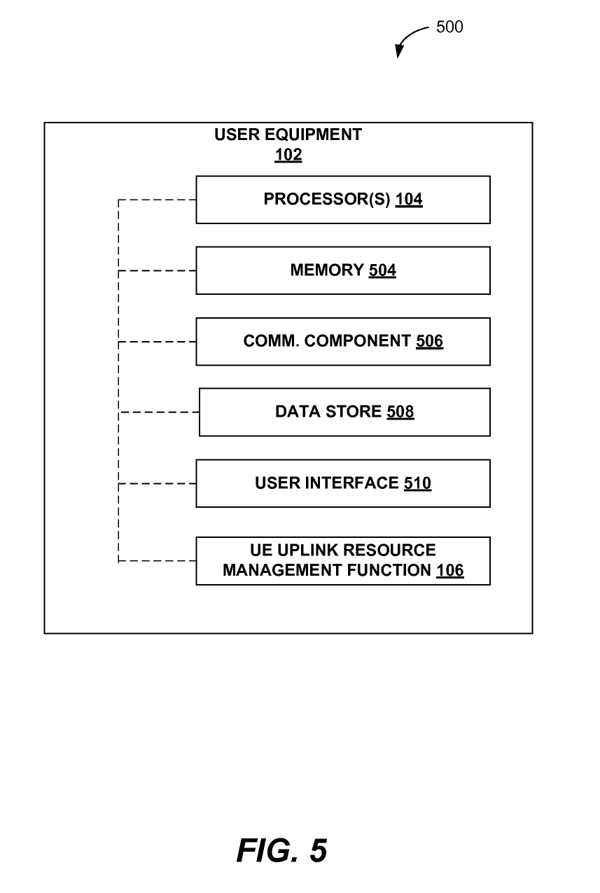

Referring to FIG. 5, in an aspect, UE 102, for example, including UE uplink resource management function 106, may be or may include a specially programmed or configured computer device to perform the functions described herein. In one aspect of implementation, UE 102 may include UE uplink resource management function 106, RLC transmission window state detecting function 108, status PDU initiating function 110, status PDU receiving function 112, and/or a PDU transmitting function 114, such as in specially programmed computer readable instructions or code, firmware, hardware, or some combination thereof.

In an aspect, for example as represented by the dashed lines, UE uplink resource management function 106 may be implemented in or executed using one or any combination of processor 104, memory 504, communications component 506, and data store 508. For example, UE uplink resource management function 106 may be executed on one or more processors 104. Further, for example, UE uplink resource management function 106 may be defined as a computer-readable medium (e.g., a non-transitory computer-readable medium) stored in memory 504 and/or data store 508 and executed by processor 104. Moreover, for example, inputs and outputs relating to operations of UE uplink resource management function 106 may be provided or supported by communications component 506, which may provide a bus between the components of computer device 500 or an interface for communication with external devices or components.

UE 102 may include processor 104 specially configured to carry out processing functions associated with one or more of components and functions described herein. Processor 104 can include a single or multiple set of processors or multi-core processors. Moreover, processor 104 can be implemented as an integrated processing system and/or a distributed processing system.

User equipment 102 further includes memory 504, such as for storing data used herein and/or local versions of applications and/or instructions or code being executed by processor 104, such as to perform the respective functions of the respective entities described herein. Memory 504 can include any type of memory usable by a computer, such as random access memory (RAM), read only memory (ROM), tapes, magnetic discs, optical discs, volatile memory, non-volatile memory, and any combination thereof.

Further, user equipment 102 includes communications component 506 that provides for establishing and maintaining communications with one or more parties utilizing hardware, software, and services as described herein. Communications component 506 may carry communications between components on user equipment 102, as well as between user and external devices, such as devices located across a communications network and/or devices serially or locally connected to user equipment 102. For example, communications component 506 may include one or more buses, and may further include transmit chain components and receive chain components associated with a transmitter and receiver, respectively, or a transceiver, operable for interfacing with external devices.

Additionally, user equipment 102 may further include data store 508, which can be any suitable combination of hardware and/or software, that provides for mass storage of information, databases, and programs employed in connection with aspects described herein. For example, data store 508 may be a data repository for applications not currently being executed by processor 104.

User equipment 102 may additionally include a user interface component 510 operable to receive inputs from a user of user equipment 102, and further operable to generate outputs for presentation to the user. User interface component 510 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

The various concepts presented throughout this disclosure may be implemented across a broad variety of telecommunication systems, network architectures, and communication standards.

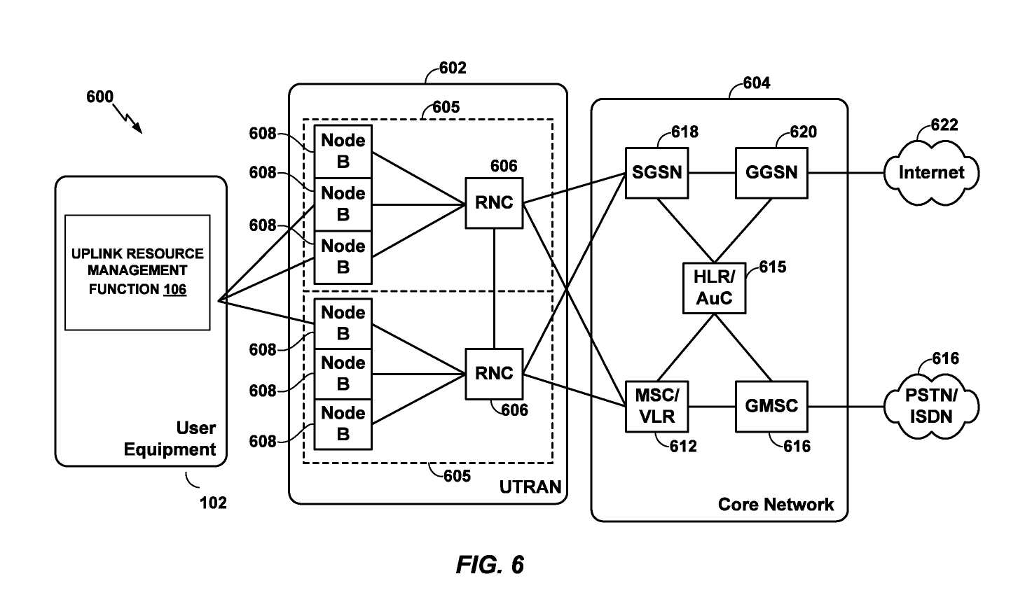

Referring to FIG. 6, by way of example and without limitation, the aspects of the present disclosure are presented with reference to a UMTS system 600 employing a W-CDMA air interface, and may include a UE 102 executing an aspect of UE uplink resource management function 106 of FIG. 1. A UMTS network includes three interacting domains: a Core Network (CN) 604, a UMTS Terrestrial Radio Access Network (UTRAN) 602, and UE 102. In an aspect, as noted, UE 102 (FIG. 1) may be configured to perform functions thereof, for example, including uplink resource management at the UE. Further, UTRAN 602 may comprise network entity 120 and/or base station 122 (FIG. 1), which in this case may be respective ones of the Node Bs 608. In this example, UTRAN 602 provides various wireless services including telephony, video, data, messaging, broadcasts, and/or other services. The UTRAN 602 may include a plurality of Radio Network Subsystems (RNSs) such as a RNS 605, each controlled by a respective Radio Network Controller (RNC) such as an RNC 606. Here, the UTRAN 602 may include any number of RNCs 606 and RNSs 605 in addition to the RNCs 606 and RNSs 605 illustrated herein. The RNC 606 is an apparatus responsible for, among other things, assigning, reconfiguring, and releasing radio resources within the RNS 605. The RNC 606 may be interconnected to other RNCs (not shown) in the UTRAN 602 through various types of interfaces such as a direct physical connection, a virtual network, or the like, using any suitable transport network.

Communication between UE 102 and Node B 608 may be considered as including a physical (PHY) layer (e.g., PHY 206) and a medium access control (MAC) layer. Further, communication between UE 102 and RNC 606 by way of a respective Node B 608 may be considered as including a radio resource control (RRC) layer (e.g., Layer 3). In the instant specification, the PHY layer may be considered layer 1; the MAC layer may be considered layer 2; and the RRC layer may be considered layer 3. Information herein below utilizes terminology introduced in the RRC Protocol Specification, 3GPP TS 66.331 v6.1.0, incorporated herein by reference.

The geographic region covered by the RNS 605 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 608 are shown in each RNS 605; however, the RNSs 605 may include any number of wireless Node Bs. The Node Bs 608 provide wireless access points to a CN 604 for any number of mobile apparatuses, such as UE 102, and may be network entity 110 and/or base station 112 of FIG. 1. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus in this case is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

For illustrative purposes, one UE 102 is shown in communication with a number of the Node Bs 608. The DL, also called the forward link, refers to the communication link from a Node B 608 to a UE 102 (e.g., link 116), and the UL, also called the reverse link, refers to the communication link from a UE 102 to a Node B 608 (e.g., link 114).

The CN 604 interfaces with one or more access networks, such as the UTRAN 602. As shown, the CN 604 is a GSM core network. However, as those skilled in the art will recognize, the various concepts presented throughout this disclosure may be implemented in a RAN, or other suitable access network, to provide UEs with access to types of CNs other than GSM networks.

The CN 604 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 604 supports circuit-switched services with a MSC 612 and a GMSC 614. In some applications, the GMSC 614 may be referred to as a media gateway (MGW). One or more RNCs, such as the RNC 606, may be connected to the MSC 612. The MSC 612 is an apparatus that controls call setup, call routing, and UE mobility functions. The MSC 612 also includes a VLR that contains subscriber-related information for the duration that a UE is in the coverage area of the MSC 612. The GMSC 614 provides a gateway through the MSC 612 for the UE to access a circuit-switched network 616. The GMSC 614 includes a home location register (HLR) 615 containing subscriber data, such as the data reflecting the details of the services to which a particular user has subscribed. The HLR is also associated with an authentication center (AuC) that contains subscriber-specific authentication data. When a call is received for a particular UE, the GMSC 614 queries the HLR 615 to determine the UE's location and forwards the call to the particular MSC serving that location.

The CN 604 also supports packet-data services with a serving GPRS support node (SGSN) 618 and a gateway GPRS support node (GGSN) 620. GPRS, which stands for General Packet Radio Service, is designed to provide packet-data services at speeds higher than those available with standard circuit-switched data services. The GGSN 620 provides a connection for the UTRAN 602 to a packet-based network 622. The packet-based network 622 may be the Internet, a private data network, or some other suitable packet-based network. The primary function of the GGSN 620 is to provide the UEs 104 with packet-based network connectivity. Data packets may be transferred between the GGSN 620 and the UEs 102 through the SGSN 618, which performs primarily the same functions in the packet-based domain as the MSC 612 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 608 and a UE 102. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 102 provides feedback to Node B 608 over the HS-DPCCH to indicate whether it correctly decoded a packet on the downlink.

HS-DPCCH further includes feedback signaling from the UE 102 to assist the Node B 608 in taking the right decision in terms of modulation and coding scheme and precoding weight selection, this feedback signaling including the CQI and PCI.

HSPA Evolved or HSPA+ is an evolution of the HSPA standard that includes MIMO and 64-QAM, enabling increased throughput and higher performance. That is, in an aspect of the disclosure, the Node B 608 and/or the UE 102 may have multiple antennas supporting MIMO technology. The use of MIMO technology enables the Node B 608 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 102 to increase the data rate or to multiple UEs 102 to increase the overall system capacity. This is achieved by spatially precoding each data stream and then transmitting each spatially precoded stream through a different transmit antenna on the downlink. The spatially precoded data streams arrive at the UE(s) 102 with different spatial signatures, which enables each of the UE(s) 102 to recover the one or more the data streams destined for that UE 102. On the uplink, each UE 102 may transmit one or more spatially precoded data streams, which enables Node B 608 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

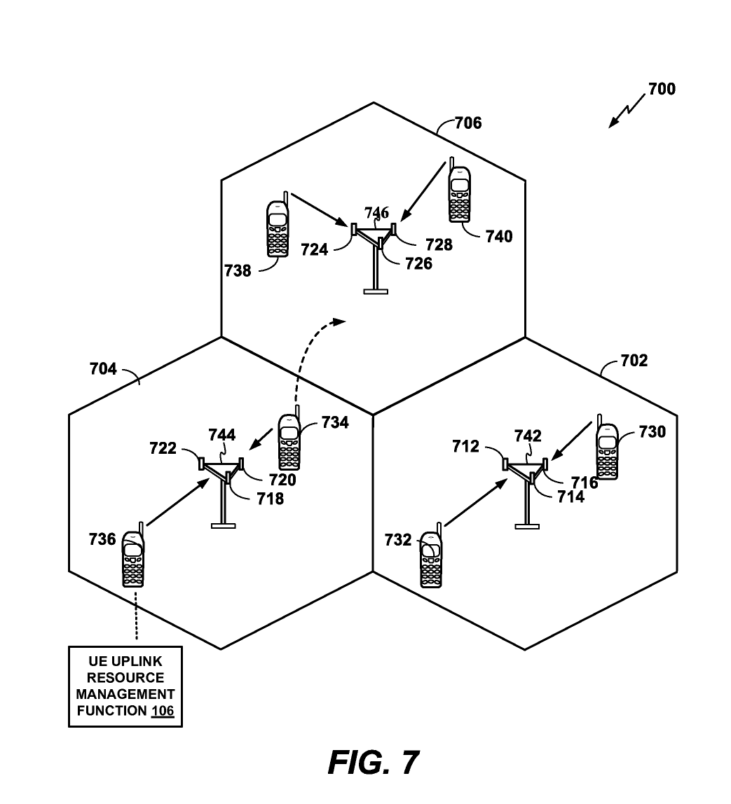

Referring to FIG. 7, an access network 700 in a UTRAN architecture is illustrated, and may include one or more UEs 730, 732, 734, 736, 738, and 740, which may be the same as or similar to UE 102 (FIG. 1) in that they are configured to include UE uplink resource management function (FIG. 1; for example, illustrated here as being associated with UE 736) for uplink resource management at the UE. The multiple access wireless communication system includes multiple cellular regions (cells), including cells 702, 704, and 706, each of which may include one or more sectors. The multiple sectors can be formed by groups of antennas with each antenna responsible for communication with UEs in a portion of the cell. For example, in cell 702, antenna groups 712, 714, and 716 may each correspond to a different sector. In cell 704, antenna groups 718, 720, and 722 each correspond to a different sector. In cell 706, antenna groups 724, 726, and 728 each correspond to a different sector. UEs, for example, 730, 732, etc. may include several wireless communication devices, e.g., User Equipment or UEs, including state transition manager 104 of FIG. 1, which may be in communication with one or more sectors of each cell 702, 704 or 706. For example, UEs 730 and 732 may be in communication with Node B 742, UEs 734 and 736 may be in communication with Node B 744, and UEs 738 and 740 can be in communication with Node B 746. Here, each Node B 742, 744, 746 is configured to provide an access point to a CN 604 (FIG. 6) for all the UEs 730, 732, 734, 736, 738, 740 in the respective cells 702, 704, and 706. Additionally, each Node B 742, 744, 746 may be base station 112 and/or and UEs 730, 732, 734, 736, 738, 740 may be UE 102 of FIG. 1 and may perform the methods outlined herein.

As the UE 734 moves from the illustrated location in cell 704 into cell 706, a serving cell change (SCC) or handover may occur in which communication with the UE 734 transitions from the cell 704, which may be referred to as the source cell, to cell 706, which may be referred to as the target cell. Management of the handover procedure may take place at the UE 734, at the Node Bs corresponding to the respective cells, at a radio network controller 606 (FIG. 6), or at another suitable node in the wireless network. For example, during a call with the source cell 704, or at any other time, the UE 734 may monitor various parameters of the source cell 704 as well as various parameters of neighboring cells such as cells 706 and 702. Further, depending on the quality of these parameters, the UE 734 may maintain communication with one or more of the neighboring cells. During this time, the UE 734 may maintain an Active Set, that is, a list of cells that the UE 734 is simultaneously connected to (i.e., the UTRA cells that are currently assigning a downlink dedicated physical channel DPCH or fractional downlink dedicated physical channel F-DPCH to the UE 734 may constitute the Active Set). In any case, UE 734 may perform the reselection operations described herein.

Further, the modulation and multiple access scheme employed by the access network 700 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 1002.11 (Wi-Fi), IEEE 1002.16 (WiMAX), IEEE 1002.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

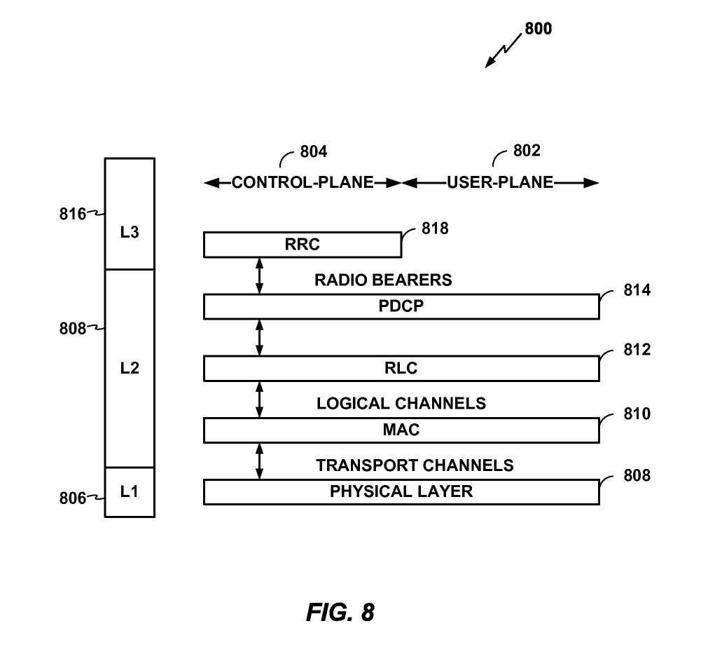

The radio protocol architecture may take on various forms depending on the particular application. An example for an HSPA system will now be presented with reference to FIG. 8. FIG. 8 is a conceptual diagram illustrating an example of the radio protocol architecture for the user plane 802 and control plane 804.

Turning to FIG. 8, the radio protocol architecture for the UE, for example, UE 102 of FIG. 1 configured to include UE uplink resource management function 106 (FIG. 1) for uplink resource management at a user equipment (e.g., UE 102) is shown with three layers: Layer 1 (L1), e.g., PHY 206 (FIGS. 2-3), Layer 2 (L2), e.g., RLC/MAC 204 (FIGS. 2-3), and Layer 3 (L3), e.g., RRC 202 (not shown in FIGS. 2-3). Layer 1 is the lowest layer and implements various physical layer signal processing functions. Layer 1 (L1 layer) is referred to herein as the physical layer 806, for example, PHY 206 of FIGS. 2 and 3. Layer 2 (L2 layer) 808 is above the physical layer 806 and is responsible for the link between the UE and Node B over the physical layer 806, for example, RLC/MAC 204 of FIGS. 2 and 3.

In the user plane, L2 layer 808 includes a media access control (MAC) sublayer 810, a radio link control (RLC) sublayer 812, and a packet data convergence protocol (PDCP) 814 sublayer, which are terminated at the Node B on the network side. Although not shown, the UE may have several upper layers above L2 layer 808 including a network layer (e.g., IP layer) that is terminated at a PDN gateway on the network side, and an application layer that is terminated at the other end of the connection (e.g., far end UE, server, etc.).

The PDCP sublayer 814 provides multiplexing between different radio bearers and logical channels. The PDCP sublayer 814 also provides header compression for upper layer data packets to reduce radio transmission overhead, security by ciphering the data packets, and handover support for UEs between Node Bs. The RLC sublayer 812 provides segmentation and reassembly of upper layer data packets, retransmission of lost data packets, and reordering of data packets to compensate for out-of-order reception due to hybrid automatic repeat request (HARQ). The MAC sublayer 810 provides multiplexing between logical and transport channels. The MAC sublayer 810 is also responsible for allocating the various radio resources (e.g., resource blocks) in one cell among the UEs. The MAC sublayer 810 is also responsible for HARQ operations.

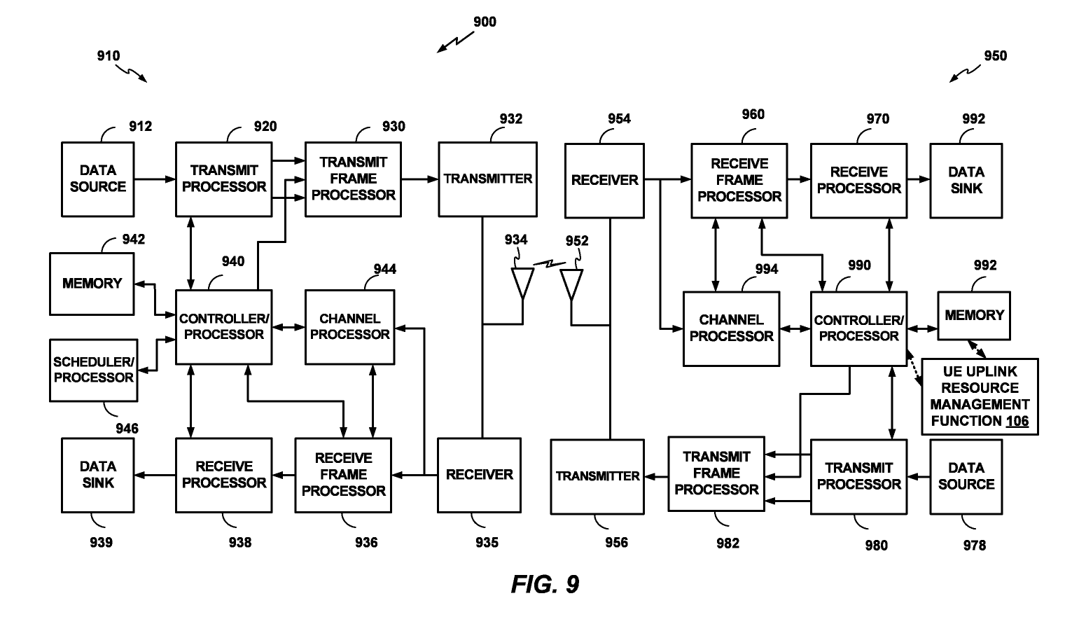

FIG. 9 is a block diagram of a Node B 910 in communication with a UE 950, where the Node B 910 may be base station 122 and/or the UE 950 may be the same as or similar to UE 102 of FIG. 1 in that it is configured to include UE uplink resource management function 106 (FIG. 1) for uplink resource management at UE, in controller/processor 990 and/or memory 992. In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback from the UE 950. The symbols generated by the transmit processor 920 are provided to a transmit frame processor 930 to create a frame structure. The transmit frame processor 930 creates this frame structure by multiplexing the symbols with information from the controller/processor 940, resulting in a series of frames. The frames are then provided to a transmitter 932, which provides various signal conditioning functions including amplifying, filtering, and modulating the frames onto a carrier for downlink transmission over the wireless medium through antenna 934. The antenna 934 may include one or more antennas, for example, including beam steering bidirectional adaptive antenna arrays or other similar beam technologies.

At UE 950, a receiver 954 receives the downlink transmission through an antenna 952 and processes the transmission to recover the information modulated onto the carrier. The information recovered by the receiver 954 is provided to a receive frame processor 960, which parses each frame, and provides information from the frames to a channel processor 994 and the data, control, and reference signals to a receive processor 970. The receive processor 970 then performs the inverse of the processing performed by the transmit processor 920 in the Node B 910. More specifically, the receive processor 970 descrambles and de-spreads the symbols, and then determines the most likely signal constellation points transmitted by the Node B 910 based on the modulation scheme. These soft decisions may be based on channel estimates computed by the channel processor 994. The soft decisions are then decoded and de-interleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receive processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the Node B 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 994 from a reference signal transmitted by the Node B 910 or from feedback contained in the midamble transmitted by the Node B 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with information from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the Node B 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides information from the frames to the channel processor 944 and the data, control, and reference signals to a receive processor 938. The receive processor 938 performs the inverse of the processing performed by the transmit processor 980 in the UE 950. The data and control signals carried by the successfully decoded frames may then be provided to a data sink 939 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the Node B 910 and the UE 950, respectively. For example, the controller/processors 940 and 990 may provide various functions including timing, peripheral interfaces, voltage regulation, power management, and other control functions. The computer readable media of memories 942 and 992 may store data and software for the Node B 910 and the UE 950, respectively. A scheduler/processor 946 at the Node B 910 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for uplink resource management at a user equipment (UE), comprising:
detecting that a radio link control (RLC) transmission window is full at the UE after acquiring high speed-random access channel (HS-RACH) resources;
initiating a message from the UE to a network entity in response to the detection for triggering transmission of a status protocol data unit (PDU) from the network entity to the UE; and
receiving the status PDU from the network entity in response to the transmission.

2. The method of claim 1, further comprising:
transmitting new PDUs or re-transmitting un-acknowledged PDUs to the network entity based at least on information received in the status PDU.

3. The method of claim 1, wherein the message is initiated instead of releasing the HS-RACH resources.

4. The method of claim 1, wherein the message includes re-transmitting a latest un-acknowledged PDU with a poll bit set to a value of one.

5. The method of claim 1, wherein the message includes a poll super field (SUFI) with a sequence number (SN) of a latest un-acknowledged PDU.

6. The method of claim 1, wherein the RLC transmission window is full at the UE when the UE transmits a maximum number of PDUs allowed without receiving acknowledgements (ACKs) or negative acknowledgements (NACKs) for PDUs transmitted from the UE to the network entity.

7. An apparatus for uplink resource management at a user equipment (UE), comprising:
means for detecting that a radio link control (RLC) transmission window is full at the UE after acquiring high speed-random access channel (HS-RACH) resources;
means for initiating a message from the UE to a network entity in response to the detection for triggering transmission of a status protocol data unit (PDU) from the network entity to the UE; and
means for receiving the status PDU from the network entity in response to the transmission.

8. The apparatus of claim 7, further comprising:
means for transmitting new PDUs or re-transmitting un-acknowledged PDUs to the network entity based at least on information received in the status PDU.

9. The apparatus of claim 7, wherein the message is initiated instead of releasing the HS_RACH resources.

10. The apparatus of claim 7, wherein the message includes re-transmitting a latest un-acknowledged PDU with a poll bit set to a value of one.

11. The apparatus of claim 7, wherein the message includes a poll super field (SUFI) with a sequence number (SN) of a latest un-acknowledged PDU.

12. The apparatus of claim 7, wherein the RLC transmission window is full at the UE when the UE transmits a maximum number of PDUs allowed without receiving acknowledgements (ACKs) or negative acknowledgements (NACKs) for PDUs transmitted from the UE to the network entity.

13. A non-transitory computer readable medium storing computer executable code for uplink resource management at a user equipment (UE), comprising:
code for detecting that a radio link control (RLC) transmission window is full at the UE after acquiring high speed-random access channel (HS-RACH) resources;
code for initiating a message from the UE to a network entity in response to the detection for triggering transmission of a status protocol data unit (PDU) from the network entity to the UE; and
code for receiving the status PDU from the network entity in response to the transmission.

14. The computer readable medium of claim 13, further comprising:
code for transmitting new PDUs or re-transmitting un-acknowledged PDUs to the network entity based at least on information received in the status PDU.

15. The computer readable medium of claim 13, wherein the message is initiated instead of releasing the HS_RACH resources.

16. The computer readable medium of claim 13, wherein the message includes re-transmitting a latest un-acknowledged PDU with a poll bit set to a value of one.

17. The computer readable medium of claim 13, wherein the message includes a poll super field (SUFI) with a sequence number (SN) of a latest un-acknowledged PDU.

18. The computer readable medium of claim 13, wherein the RLC transmission window is full at the UE when the UE transmits a maximum number of PDUs allowed without receiving acknowledgements (ACKs) or negative acknowledgements (NACKs) for PDUs transmitted from the UE to the network entity.

19. An apparatus for uplink resource management at a user equipment (UE), comprising:
a radio link control (RLC) transmission window state detecting function to detect that a radio link control (RLC) transmission window is full at the UE after acquiring high speed-random access channel (HS-RACH) resources;
a status protocol data unit (PDU) initiating function to initiate a message from the UE to a network entity in response to the detection for triggering transmission of a status protocol data unit (PDU) from the network entity to the UE; and
a status PDU receiving function to receive the status PDU from the network entity in response to the transmission.

20. The apparatus of claim 19, further comprising:
a PDU transmitting function to transmit new PDUs or re-transmitting un-acknowledged PDUs to the network entity based at least on information received in the status PDU.

21. The apparatus of claim 19, wherein the message is initiated instead of releasing the HS_RACH resources.

22. The apparatus of claim 19, wherein the message includes re-transmitting a latest un-acknowledged PDU with a poll bit set to a value of one.

23. The apparatus of claim 19, wherein the message includes a poll super field (SUFI) with a sequence number (SN) of a latest un-acknowledged PDU.

24. The apparatus of claim 19, wherein the RLC transmission window is full at the UE when the UE transmits a maximum number of PDUs allowed without receiving acknowledgements (ACKs) or negative acknowledgements (NACKs) for PDUs transmitted from the UE to the network entity.
